(19) United States
(12) Patent Application Publication
(10) Pub. No.: US 2012/0093195 A1
(43) Pub. Date: Apr. 19, 2012

(54) ULTRA-WIDEBAND TRANSMITTER UNIT

(75) Inventors: Reiner Krapf, Reutlingen (DE); Heiko Braun, Leinfelden-Echterdingen (DE); Michael Mahler, Leinfelden-Echterdingen (DE)

(73) Assignee: Robert Bosch GMBH, Stuttgart (DE)

(21) Appl. No.: 12/677,884

(22) PCT Filed: Jul. 15, 2008
(86) PCT No.: PCT/EP08/59228

§ 371 Date: Oct. 22, 2010

(30) Foreign Application Priority Data
Sep. 12, 2007 (DE) 10200704388.1

(51) Int. Cl. H04B 1/00

(52) U.S. Cl. 375/130

(57) ABSTRACT

The invention relates to an ultra-wideband transmitter unit for a hand-held machine tool, particularly for a sensor device. Said ultra-wideband transmitter unit is provided for transmitting a transmission signal having a line spectrum. According to the invention, the ultra-wideband transmitter unit comprises an adjusting unit (10) that is provided for adjusting a position of at least one spectral line (22) of the line spectrum.

### STATE OF THE ART

The invention relates to an ultra-wideband transmitter unit according to the generic term of claim 1.

Ultra-wideband transmitter units for hand-held machine tools, in particular for sensor devices, are already known, whereby the ultra-wideband transmitter units are provided for transmitting a transmitting signal with a line spectrum.

It is suggested that the ultra-wideband transmitter unit comprises an adjusting unit, which is provided to adjust a position of at least one spectral line of the line spectrum, whereby a line spectrum particularly means a frequency spectrum, which provides the discrete spectral lines, which particularly lie in an area of a radio service. A “position” shall mean in this context in particular a position of an average frequency of the corresponding line. “Provided” shall particularly mean customized, construed and/or programmed. By adjusting the position of the spectral line it can thereby be avoided that the spectral line overlaps with a signal of the radio service and thereby interferes with the signal of the radio service. A “radio service” shall mean in this context in particular active and/or passive radio services, which have a right of use for a frequency spectrum, as for example GSM-services, UMTS-services, meteorological radio services, TV- and radio services and/or radar services.

Advantageously the adjusting unit is provided to adjust a position of the spectral line, which is outside of the signal of the radio service. “Outside” shall mean in this context in particular that a distance of the spectral line and the interfering line is bigger than the sum of half of the line width of the spectral line and half of the line width of the signal of the radio service. Thereby it is avoided that the signal of the radio service and the spectral lines overlap and cannot be separated anymore. A line width means in this context in particular a half-power width of the corresponding line.

It is furthermore suggested that the adjusting unit is provided to adjust the position of at least a second spectral line. Thereby an interference of the radio service can be minimized particularly effectively.

Thereby it is suggested that the adjusting unit is provided to adjust a position of the second spectral line, in which the position of the signal of the radio service lies basically in the middle between the first spectral line and the second spectral line. “Basically” shall mean in this context in particular that a position of the signal of the radio service deviates by less than 10% of the distance of both spectral lines from an exact middle position, whereby a value smaller than 5% is advantageous and a value equal to zero is especially advantageous. Such a position of the signal of the radio service of the radio service is especially advantageous because a distance of the signal of the radio service to adjoining spectral lines gets particularly big.

Advantageously the adjusting unit is provided to adjust the position of the second spectral line independent from the position of the first spectral line, whereby the positions of the first and second spectral line can be adjusted particularly easily, so that the position of the signal of the radio service lies basically in the middle between the first spectral line and the second spectral line.

The adjusting unit is furthermore advantageously provided to adjust a distance between the first spectral line and at least a further spectral line, which is bigger than a line width of a signal of a radio service. Thereby an interference of the radio service can be avoided particularly easily. The distance between the spectral lines can be adjusted particularly easily if the positions of the spectral lines can be adjusted independent of each other. But it is basically also possible to adjust a distance between two spectral lines, if the spectral lines can only be shifted together but by different amounts.

It is suggested that the transmitting signal is construed as repetitive pulse signal, which provides a pulse repetition frequency. A “pulse repetition frequency” shall in particular mean a signal, which provides pulses, which are transmitted in regular intervals. At such transmitting signals the distances of the spectral lines can be easily shifted by changing the pulse repetition frequency. Additionally the absolute positions of the spectral lines can be shifted together at such a signal, if the ultra-wideband unit provides a modulator, which is provided to modulate the repetitive pulse signal. Thereby an independent adjustment of the positions of two spectral lines can be easily realized.

It is also advantageous if the transmitting signal is construed as a pseudo-noise-signal, which provides a period of a repetitive pseudo-noise-sequence. A “pseudo-noise-signal” shall in particular mean a signal, which provides a periodically repetitive sequence. At such a transmitting signal the distance of the spectral lines can also be easily adjusted why such a transmitting signal can be advantageously used as an alternative or as an addition to the repetitive pulse signal. The position of the spectral lines can also be shifted with the aid of a modulator at the pseudo-noise-signal, whereby an independent adjustment of the positions of two spectral lines can be realized.

### DRAWING

Further advantages arise from the following drawing description. The drawings show an embodiment of the invention. The drawings, the description and the claims contain several characteristics in combination. The expert will consider these characteristics also individually and wrap them up into further useful combinations.

It is shown in:

FIG. 1 a schematic construction of a transmitting unit,

FIG. 2 a frequency spectrum with a line spectrum of a transmitter and with a signal of a radio service,

FIG. 3 a frequency spectrum, at which the signal of the radio service lies between two spectral lines and

FIG. 4 a frequency spectrum, at which the signal of the radio service lies in the middle of two spectral lines.

### DESCRIPTION OF THE EMBODIMENTS

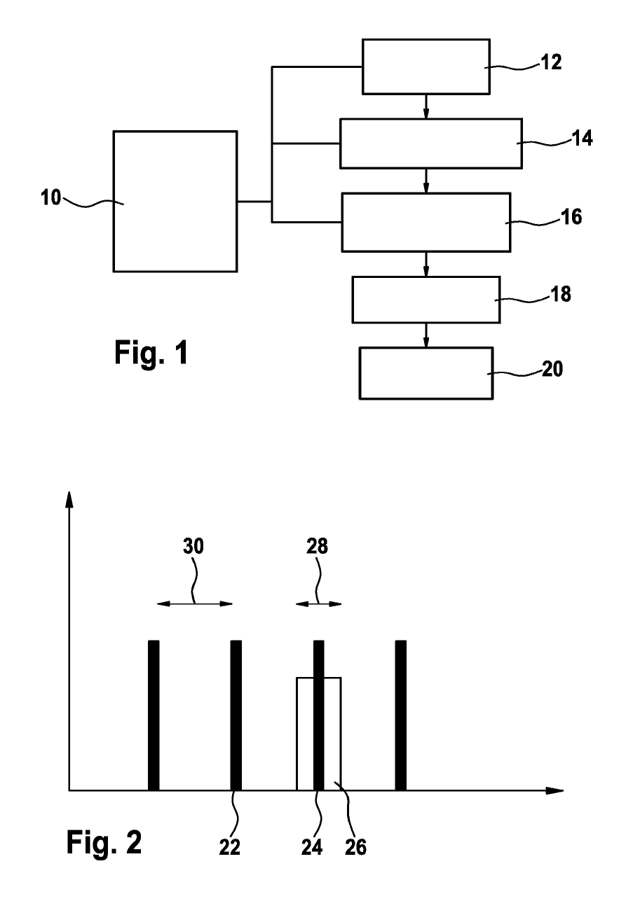

FIG. 1 schematically shows the construction of an ultra-wideband transmitter unit of a not further illustrated sensor device, which is provided for analyzing surfaces, as for example walls and/or floor surfaces. The ultra-wideband transmitter unit transmits a transmitting signal, which provides a frequency spectrum with a line spectrum. The transmitting signal is reflected by structures below the surface and a reflecting signal is detected by a not further illustrated receiver unit. With the aid of an evaluation electronic the reflected signal implies the structures below the surface which can be illustrated on a display of the sensor device.

The transmitting signal, which is transmitted by the ultra-wideband transmitter unit, is construed as a repetitive pulse signal, which provides a pulse repetition frequency. The ultra-wideband transmitter unit comprises a frequency default unit 12, which defaults a basic frequency and can for example be construed by a micro controller, quartz or a PLL. The base frequency, which has been generated by the frequency default unit 12, is transmitted to a signal production unit 14, which produces a pulsed signal from the base frequency. The signal production unit 14 can for example be construed by a step-recovery-diode, a transistor and/or other components that seem to be useful for the expert. Subsequently the signal is send to a modulator 16. The modulated signal can be changed and adjusted for example by passive components 18, as for example filter, divider, coupler, balun etc, and subsequently radiated over an antenna 20.

At the transmitting signal that is construed as repetitive pulse signal a distance 30 of spectral lines 22, 24 of the line spectrum can be changed with the aid of a variation of the pulse repetition frequency, whereby the distance 30 can basically be increased as well as reduced. A position of the spectral lines 22, 24 can be adjusted by a modulation of the transmitting signal, which takes place with the aid of the modulator 16. In order to change the position and the distance 30 of the spectral lines 22, 24, the ultra-wideband transmitter unit comprises an adjusting unit 10, which can affect the frequency default unit 12, the signal production unit 14 and the modulator 16. By adjusting the distance 30 and by adjusting the positions of the spectral lines 22, 24 together, it is possible to adjust the position of the first spectral line 22 independent of the position of the second spectral line 24.

A frequency spectrum, in which one of the spectral lines 24 of the transmitting signal with a signal of a radio service 26 concur, is shown in FIG. 2. The signal of the radio service 26 is interfered by the transmitting signal. The spectral lines 22, 24 and the signal of the radio service 26 provide a rectangular form in the frequency spectrum, why a half width equals an entire width.

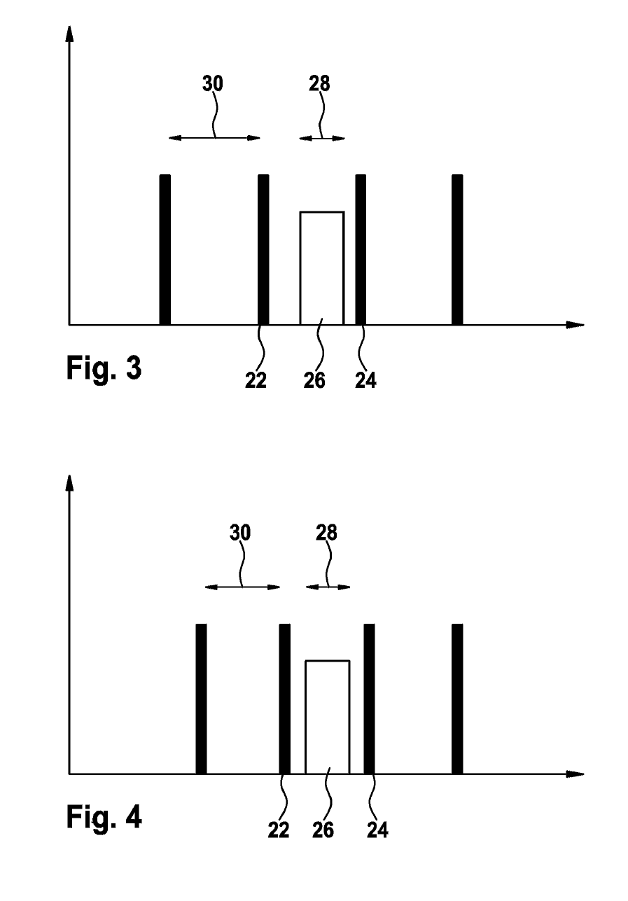

In order to minimize an interference of the signal of the radio service 26 the position of the spectral line 22 and the spectral line 24 is adjusted with the aid of the adjusting unit 10 in such a way that the spectral lines 22, 24 lie outside of the signal of the radio service 26 (FIG. 3). Furthermore the distance 30 between the spectral line 22 and the spectral line 24 is adjusted by the adjusting unit 10 with the aid of the modulator 16 in such a way that it is bigger than a line width 28 of the signal of the radio service 26.

FIG. 4 shows a frequency spectrum, at which—compared to FIG. 2—the distance 30 of the spectral lines 22, 24 has been maintained. The spectral lines 22, 24 have been shifted together by the adjusting unit 10 by a common amount, whereby the signal of the radio service 26 lies basically in the middle between the two spectral lines 22, 24. The distance 30 is bigger than the line width 28 of the signal of the radio service 26.

The ultra-wideband transmitter unit can alternatively and additionally transmit a transmitting signal, which is construed as pseudo-noise-signal with a period of a repetitive pseudo-noise-sequence. A modulation frequency and the duration of the pseudo-noise-signal are then defaulted by the frequency default unit 12. Subsequently a pseudo-noise-sequence is produced by the signal production unit 14, which can be subsequently modulated with the aid of the modulator 16. The signal production unit 14 and the modulator 16 can be construed in one piece and could also comprise for example a FPGA-circuit or an IC. The modulated signal can be changed and adjusted once more by the passive components and is subsequently radiated over the antenna 20.

At the transmitting signal that is construed as pseudo-noise-signal the distance 30 of the spectral lines 22, 24 can be changed with the aid of an variation of the period, whereby the distance 30 can basically be increased and also reduced. The position can again be adjusted over a modulation of the transmitting signal.

1. Ultra-wideband transmitter unit for a handheld machine tool, in particular for a sensor device, wherein the ultra-wideband transmitter unit is provided to transmit a transmitting signal with a line spectrum, is characterized by an adjusting unit, which is provided to adjust a position of at least one spectral line of the line spectrum.

2. Ultra-wideband transmitter unit according to claim 1 wherein the adjusting unit is provided to adjust a position of the spectral line, which is located of a signal of a radio service.

3. Ultra-wideband transmitter unit according to claim 1, wherein the adjusting unit is provided to adjust a position of at least a second spectral line.

4. Ultra-wideband transmitter unit according to claim 3 wherein the adjusting unit is provided to adjust the position of the second spectral line independent of the position of the first spectral line.

5. Ultra-wideband transmitter unit according to claim 1, wherein the adjusting unit is provided to adjust a distance between the spectral line and at least a further spectral line, which is bigger than a line width of a signal of a radio service.

6. Ultra-wideband transmitter unit according to claim 1, wherein the adjusting unit is provided to adjust a position of at least the spectral line, in which a signal of a radio service lies basically in the middle between the spectral line and a second spectral line.

7. Ultra-wideband transmitter unit according to claim 1, wherein the transmitting signal is construed as repetitive pulse signal, which provided a pulse repetition frequency.

8. Ultra-wideband transmitter unit according to claim 1, wherein the transmitting signal is construed as a pseudo-noise-signal, which provides a period of a repetitive pseudo-noise-sequence.

9. Procedure for an ultra-wideband transmitter unit for avoiding an interference of a signal of a radio service, in particular an ultra-wideband transmitter unit according to claim 1, wherein a position of at least one spectral line of the line spectrum is adjusted.

10. Procedure according to claim 9 wherein a position of the spectral line is adjusted, which is located outside of the signal of the radio service.

11. Procedure according to claim 9 wherein a position of a second spectral line is adjusted, in which the signal of the radio service is basically located in the middle between the first spectral line and the second spectral line.

12. Procedure according to claim 11 wherein the position of the second spectral line is adjusted independent of the first spectral line.

13. Procedure according to claim 12 wherein a distance of the spectral lines is adjusted, which is bigger than a line width of the signal of the radio service.
